(19) United States
(12) Patent Application Publication
(10) Pub. No.: US 2009/0130503 A1
(43) Pub. Date: May 21, 2009

(54) Fuelling System for Fuel Cell

(76) Inventor: Donald James Highgate, Surrey (GB)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/305,239

(22) PCT Filed: Jun. 25, 2007
(86) PCT No.: PCT/GB2007/002350

§ 371 Date: Feb. 5, 2009

(30) Foreign Application Priority Data
Jun. 24, 2006 (GB) 06112567.8

(51) Int. Cl. H01M 8/04; H01M 2/02

(52) U.S. Cl. 429/14; 429/34

(57) ABSTRACT

A fuelling system comprises a hydrogen/oxygen fuel cell having hydrogen and oxygen compartments, and a vessel having first and second chambers, the first chamber connected to the hydrogen compartment and the second chamber connected to the oxygen compartment, via valved ports, wherein the volume of the first chamber is approximately twice the volume of the second chamber. Such a fuelling system is suitable for use in a method of fuelling a hydrogen/oxygen fuel cell having hydrogen and oxygen compartments, which comprises supplying hydrogen from a first chamber of a vessel to the hydrogen compartment, and supplying oxygen from a second chamber of the vessel to the oxygen compartment, wherein the hydrogen and oxygen are supplied in a stoichiometric ratio and at substantially equal pressures.

### FIELD OF THE INVENTION

This invention relates to fuelling systems for hydrogen/oxygen fuel cells.

### BACKGROUND OF THE INVENTION

Fuel cells convert a fuel and an oxidant into electricity and chemical products within a two-chamber electrochemical cell. The product electricity may be used to power a variety of devices.

One type of hydrogen/oxygen fuel cell is an air-breathing fuel cell. This type of fuel cell is supplied by a single pressurised hydrogen cylinder and an air-breathing system. An air pump is normally required to pressurise the air and force it through the cell. The air pump is heavy and requires a great deal of power. This reduces the net output of the cell and therefore makes it expensive to run. Further, an air-breathing fuel cell is dependent on the environment, meaning that it may be unsuitable for use in a polluted atmosphere or for underwater applications.

Other fuel cells utilise gaseous hydrogen (H₂) and oxygen (O₂), which are delivered to the anode and cathode chamber via separate canisters. These fuel cells are, on average, more than 15% more efficient than air-breathing fuel cells. However, they are still very expensive to run as additional pumping devices may be required, especially if the hydrogen and oxygen are at different pressures. This system also has a high balance of plant.

The development of portable power devices, using hydrogen/oxygen fuel cells, requires simple and portable gas delivery systems.

### SUMMARY OF THE INVENTION

The present invention is based on the realisation that the development of a single vessel for fuelling hydrogen/oxygen fuel cells, which carries both hydrogen and oxygen, in predefined levels at equal pressures, provides the opportunity to reduce the weight, size, complexity and number of fuelling devices required.

According to a first aspect, the present invention is a fuelling system comprising a hydrogen/oxygen fuel cell having hydrogen and oxygen compartments, and a vessel having first and second chambers, the first chamber connected to the hydrogen compartment and the second chamber connected to the oxygen compartment, via valved ports, wherein the volume of the first chamber is approximately twice the volume of the second chamber.

According to a second aspect, the present invention is a method of fuelling a hydrogen/oxygen fuel cell having hydrogen and oxygen compartments, which comprises supplying hydrogen from a first chamber of a vessel to the hydrogen compartment, and supplying oxygen from a second chamber of the vessel to the oxygen compartment, wherein the hydrogen and oxygen are supplied in a stoichiometric ratio and at substantially equal pressures.

### DESCRIPTION OF PREFERRED EMBODIMENTS

A fuelling system of the invention comprises a hydrogen/oxygen fuel cell and a vessel having first and second chambers. The vessel is used to supply hydrogen and oxygen to the fuel cell. The components of the invention may be integral, or provided separately and then connected together.

A vessel of the invention has two chambers. It is intended that hydrogen is contained in the first chamber, and that oxygen is contained in the second chamber. The volume of the first chamber is approximately double the volume of the second chamber. The oxygen and hydrogen in the vessel are at substantially equal pressures, meaning that they will be supplied to the fuel cell in a stoichiometric ratio.

As the gases are held at substantially equal pressures in the vessel, only the outer edge of the vessel will be required to withstand pressure differentials. The internal separations between the two chambers will only be required to withstand small differences in pressure. This internal separation may be a solid structure, or may be moveable to allow for corrections for small pressure differentials in the vessel.

In a preferred embodiment, the vessel is connected to a water electrolyser having hydrogen and oxygen electrode compartments. The hydrogen electrode compartment is connected to the first chamber of the vessel, and the oxygen electrode compartment is connected to the second chamber of the vessel, by valved ports. The electrolyser may be used to supply hydrogen and oxygen to the vessel.

In a more preferred embodiment, the water electrolyser is a high pressure electrolyser. The fact that the electrolyser produces gas in the 2:1 ratio necessary for complete recombination, and the fact that both gases are pressurised, is advantageous; the balance of plant necessary to achieve adequate gas flow through the system is reduced, as no pumps are required.

In one embodiment, the valved port connecting the hydrogen compartment of the water electrolyser to the first chamber of the vessel includes a vent. This allows hydrogen to be diverted to the atmosphere, or into a separate container, and results in there being a slight excess of oxygen in the vessel. This ensures that the vessel will be completely empty of hydrogen, and therefore safe, on removal.

A vessel of the invention may be used to fuel a hydrogen/oxygen fuel cell, filling integral storage chambers, and then removed. It may also be recycled, to allow multiple uses. Alternatively, a vessel of the invention may fit onto the fuel cell and remain in position during use. When designed for this purpose, it may be beneficial to have two vessels. This allows gases to flow from one vessel to the other in turn, creating a fuel and oxidant flow of gases in a closed, environment-independent system.

A fuelling system of the invention has several advantages over the prior art, i.e. a fuel cell supplied by separate hydrogen and oxygen cylinders. Firstly, a vessel of the invention is much lighter than separate hydrogen and oxygen canisters. Secondly, as the hydrogen and oxygen are at equal pressures, only one (external) wall able to withstand a high pressure differential, is required. In addition to reducing the weight of the system, this results in a smaller logistical footprint. A fuelling system of the invention also has reduced volume compared to the prior art, as there is a greater packing efficiency in one vessel than in two separate storage vessels. Another advantage of this system is that it provides the connection between an electrolyser and a fuel cell, therefore filling the gap in the hydrogen and oxygen supply systems. A system of the invention provides for the production, collection, delivery and use of stoichiometric hydrogen and oxygen.

The invention will now be described, by way of example only, with reference to the accompanying drawings.

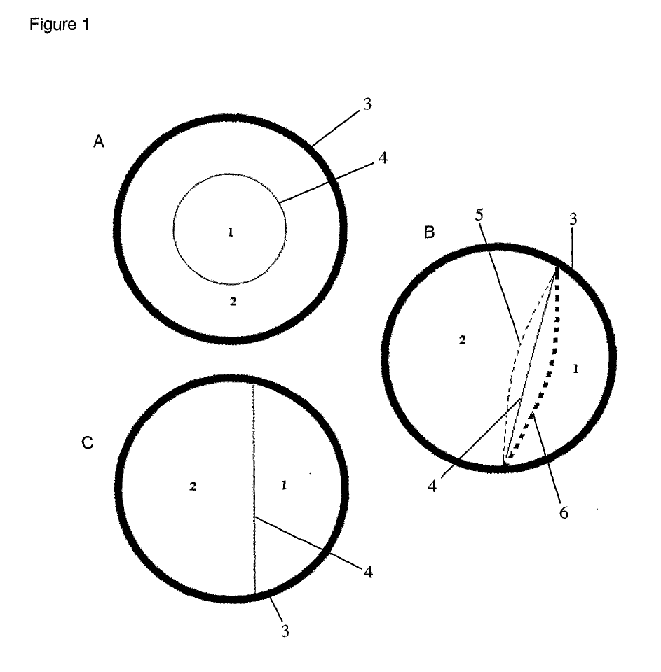

FIG. 1 is a schematic cross-sectional view of three vessels suitable for use in a system embodying the present invention. It shows vessels (A, B and C) suitable for operation with a hydrogen/oxygen fuel cell (not shown).

All the vessels in the drawing contain two chambers (1, 2) having volumes in a 1:2 ratio. Chamber 1 will contain oxygen, and chamber 2 will contain hydrogen. The outer casing (3) may be made from a high pressure-resistant metal or a composite cylinder. The inner wall (4) is not required to withstand a high pressure differential. The dotted lines illustrate how a moveable or flexible separator may conform to apply a correction for small pressure differentials. The inner wall may be flexible to allow for corrections in pressure. The thin dashed line (5) represents the position of the inner wall when correcting for high oxygen pressure and the thick dashed line (6) represents a correction for high hydrogen pressure.

Vessel A is a cylindrical vessel, in which the chambers are coaxial. This is a particularly preferred embodiment. The fact that the chambers are coaxial means that the relative radii of the chambers, required to give a 2:1 volume ratio, are easily calculated. Further it naturally facilitates a coaxial arrangement of the valved ports of the hydrogen and oxygen coupling system, which is preferred for safety and ease of use.

1. A fuelling system comprising a hydrogen/oxygen fuel cell having hydrogen and oxygen compartments, and a vessel having first and second chambers, the first chamber connected to the hydrogen compartment and the second chamber connected to the oxygen compartment, via valved ports, wherein the volume of the first chamber is approximately twice the volume of the second chamber.

2. The system according to claim 1, additionally comprising a water electrolyser having hydrogen and oxygen electrode compartments, the hydrogen electrode compartment connected to the first chamber of the vessel and the oxygen electrode compartment connected to the second chamber of the vessel, via valved ports.

3. The system according to claim 2, wherein the water electrolyser is a high pressure electrolyser.

4. The system according to claim 1, wherein the vessel is cylindrical and the chambers are coaxial.

5. A method of fuelling a hydrogen/oxygen fuel cell having hydrogen and oxygen compartments, which comprises supplying hydrogen from a first chamber of a vessel to the hydrogen compartment and supplying oxygen from a second chamber of the vessel to the oxygen compartment, wherein the hydrogen and oxygen are supplied in a stoichiometric ratio and at substantially equal pressures.

6. The method according to claim 5, additionally comprising supplying hydrogen from a hydrogen electrode compartment of a water electrolyser into the first chamber of the vessel, and supplying oxygen from an oxygen electrode compartment of the water electrolyser into the second chamber of the vessel.

7. The method according to claim 6, wherein the water electrolyser is a high pressure electrolyser.
